(19) United States
(12) Patent Application Publication
(10) Pub. No.: US 2026/0356447 A1
(43) Pub. Date: Nov. 12, 2026

(54) PIVOT JOINT ASSEMBLY FOR A WORK MACHINE

(71) Applicant: CNH Industrial America LLC, New Holland, PA (US)

(72) Inventors: Logan Wellman, Fargo, ND (US); Jacob Adam, Floyds Knobs, IN (US); Jamsheed Reshad, Newburgh, IN (US)

(21) Appl. No.: 19/205,097

(22) Filed: May 12, 2025

(51) Int. Cl. B62D 55/112; B62D 55/084; B62D 55/088; B62D 55/125; B62D 55/14

(52) U.S. Cl. CPC B62D 55/112; B62D 55/084; B62D 55/088; B62D 55/125; B62D 55/14

(57) ABSTRACT

A pivot joint assembly for a work machine includes a first member defining a first pin channel. At least a portion of the first pin channel is sealed to form a sealed chamber. Additionally, the pivot joint assembly includes a second member defining a second pin channel. The second member is positioned relative to the first member such that the second pin channel is axially aligned with the first pin channel. Moreover, the pivot joint assembly includes a pivot pin that extends axially through the aligned first and second pin channels of the first and second members, respectively. Additionally, the pivot joint assembly includes a thrust element that is positioned within the sealed chamber or forming at least a portion of the sealed chamber of the first member.

### FIELD

The present disclosure generally relates to work machines, such as agricultural machines, and, more particularly, to pivot joint assemblies for use with work machines.

### BACKGROUND

It is well known that work machines include pivot joints, which may permit relative movement between components thereof. For example, current work vehicles and/or implements, such as tractors, harvesters, seeders, tillage implements, and other agricultural machines, include at least one axle assembly for transferring torque to the machine's wheels or tracks. For instance, for a track-driven vehicle, a drive wheel of each track assembly is typically rotationally coupled to an axle assembly of the vehicle for transferring torque transmitted from the engine to the track assembly. As is generally understood, each drive wheel may be configured to rotationally engage a corresponding endless track of the associated track assembly such that rotation of the drive wheel rotates the track, thereby permitting the vehicle to be driven forward or backward. Each track assembly or other assembly of a work machine may include components, such as roller wheels, which may rotate or pivot about a pivot joint.

Pivot joints of work machines are often exposed to inhospitable environments or scenarios. For example, pivot joints may be exposed to harmful matter, such as dirt and abrasive particles, particularly as a result of work machine usage in dirty environments such as agricultural fields. In addition, aggressive rotation or other movement of components at a pivot joint may result in undesired or premature wearing of the pivot joint.

To date, various pivot joints have been developed for work machines that attempt to provide desired performance of the work machines. However, such conventional pivot joints still lack the capability of providing adequate protection to components of the pivot joints, such as adequate protection to the pivot joints when exposed to inhospitable environments or scenarios.

Accordingly, an improved pivot joint assembly for use with a work machine would be welcomed in the technology.

### SUMMARY

Aspects and advantages of the technology will be set forth in part in the following description, or may be obvious from the description, or may be learned through practice of the technology.

In one aspect, the present subject matter is directed to a track assembly for a track-driven work machine. The track assembly includes a track. Additionally, the track assembly includes a drive wheel configured to engage the track. Furthermore, the track assembly includes an idler wheel around which the track is wrapped. Moreover, the track assembly includes a pivot joint assembly. The pivot joint assembly includes a first member. The first member defines a first pin channel. At least a portion of the first pin channel is sealed to form a sealed chamber. Additionally, the pivot joint assembly includes a second member. The second member defines a second pin channel. Furthermore, the second member is positioned relative to the first member such that the second pin channel of the second member is axially aligned with the first pin channel of the first member. Moreover, the pivot joint assembly includes a pivot pin. The pivot pin extends axially through the aligned first and second pin channels of the first and second members, respectively. Additionally, the pivot joint assembly includes a thrust element. The thrust element is positioned within the sealed chamber or forming at least a portion of the sealed chamber of the first member.

In another aspect, the present subject matter is directed to a pivot joint assembly for a work machine. The pivot joint assembly includes a first member. The first member defines a first pin channel. At least a portion of the first pin channel is sealed to form a sealed chamber. Additionally, the pivot joint assembly includes a second member. The second member defines a second pin channel. Furthermore, the second member is positioned relative to the first member such that the second pin channel of the second member is axially aligned with the first pin channel of the first member. Moreover, the pivot joint assembly includes a pivot pin. The pivot pin extends axially through the aligned first and second pin channels of the first and second members, respectively. Additionally, the pivot joint assembly includes a thrust element. The thrust element is positioned within the sealed chamber or forming at least a portion of the sealed chamber of the first member.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a track-driven work vehicle in accordance with aspects of the present subject matter;

FIG. 2 illustrates a perspective view of one embodiment of a track assembly suitable for use with the work vehicle shown in FIG. 1 in accordance with aspects of the present subject matter;

FIG. 3 illustrates a side view of one embodiment of a track assembly suitable for use with the work vehicle shown in FIG. 1 in accordance with aspects of the present subject matter, particularly illustrating an interior side of the track assembly with multiple components of the track assembly exposed;

FIG. 4 illustrates a perspective view of one embodiment of a pivot joint assembly suitable for use with a work machine, such as with the track-driven work vehicle of FIG. 1, in accordance with aspects of the present subject matter;

FIG. 5 illustrates a partially exploded view of the pivot joint assembly of FIG. 4; and

FIG. 6 illustrates a side cross-sectional view of the pivot joint assembly taken about line 4-4 in FIG. 4.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to an improved pivot joint assembly for a work machine, such as a work vehicle and/or implement. Specifically, the pivot joint assembly includes a first member and a second member configured to rotate relative to each other.

In several embodiments, the first member defines a first pin channel, at least a portion of which is sealed to form a sealed chamber within the first member. Additionally, the second member defines a second pin channel. The second member is positioned relative to the first member such that the second pin channel of the second member is axially aligned with the first pin channel of the first member. Additionally, in several embodiments, the pivot joint assembly includes a pivot pin that extends axially through the aligned first and second pin channels of the first and second members, respectively.

Additionally, in several embodiments, the pivot joint assembly includes one or more thrust elements. In accordance with aspects of the present subject matter, the thrust element(s) may be positioned within or form at least a portion of the sealed chamber of the first member.

It should be appreciated that the disclosed pivot joint assembly provides enhanced protection from inhospitable environments, e.g., dirt, abrasive particles, in the form of a sealed chamber/sealed housing. Such enhanced protection of the pivot joint assembly may prevent undesired or premature wearing of the pivot joint assembly, which may prolong the usable life of the pivot joint assembly and, thus, lead to reduced maintenance and cost.

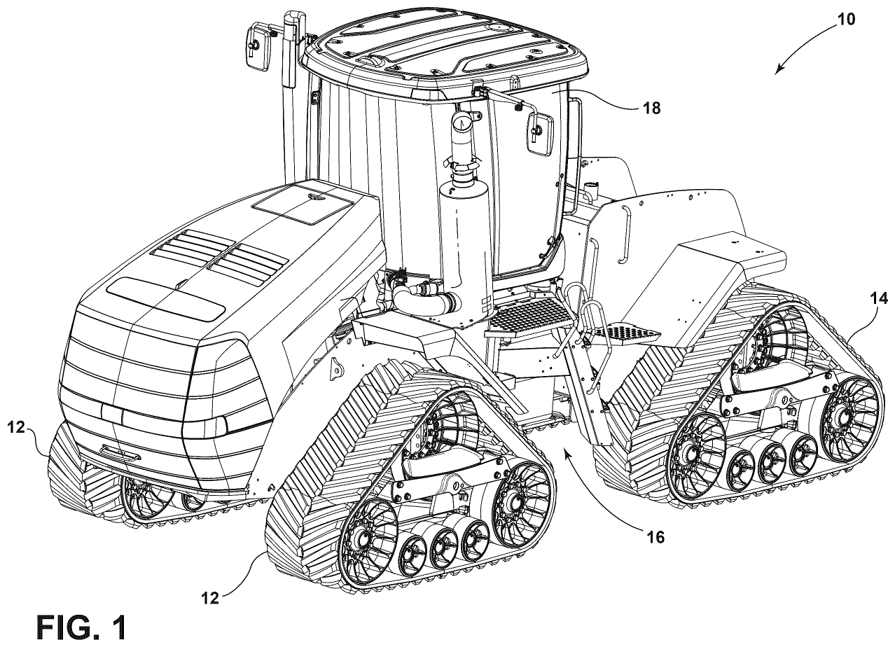

Referring now to the drawings, FIG. 1 illustrates a perspective view of one embodiment of a work vehicle 10. As shown, the work vehicle 10 is configured as an agricultural tractor. However, in other embodiments, the work vehicle 10 may be configured as any other suitable work vehicle known in the art, including those for agricultural and construction applications, transport, sport, and/or the like.

As shown in FIG. 1, the work vehicle 10 includes a pair of front track assemblies 12, a pair of rear track assemblies 14 (only one of which is shown), and a vehicle chassis 16 coupled to and supported by the track assemblies 12, 14. Additionally, an enclosed operator's cab 18 is supported by a portion of the vehicle chassis 16 and may house various control devices (not shown) for permitting an operator to control the operation of the work vehicle 10.

It should be appreciated that the configuration of the work vehicle 10 described above and shown in FIG. 1 is provided only to place the present subject matter in an exemplary field of use. Thus, it should be apparent that the present subject matter may be readily adaptable to any manner of work vehicle configuration. For example, in an alternative embodiment, the work vehicle 10 may include an open operator's cab 18 and/or may be configured to be operably coupled to any suitable type of work implement, such as a trailer, spray boom, manure tank, feed grinder, plow and/or the like.

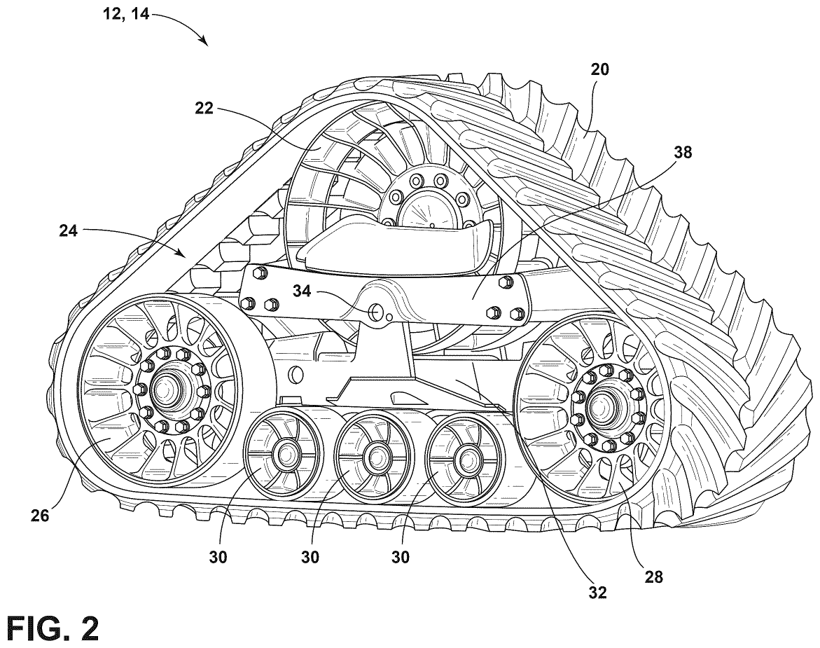

Referring now to FIG. 2, a perspective view of an exemplary embodiment of one of the front track assemblies 12, 14 shown in FIG. 1 is illustrated in accordance with aspects of the present subject matter. As shown, the track assembly 12, 14 may generally include a track 20, a drive wheel 22 for mechanically engaging the track 20, and a suspension system 24 for supporting the weight of the work vehicle 10 and for damping vibrations and other movement between the track 20 and the vehicle chassis 16. In one embodiment, the suspension system 24 may include front and rear idler wheel assemblies 26, 28 about which the track 20 is wrapped and a plurality of roller wheel assemblies 30 for guiding the track 20 between the idler wheel assemblies 26, 28. Additionally, the suspension system 24 may include one or more undercarriage support beams, such as undercarriage support beam 32, configured to support the idler wheel assemblies 26, 28 and the roller wheel assemblies 30 relative to the track 20. For example, as shown in FIG. 2, the undercarriage support beam 32 may extend fore-to-aft within the track assembly 12, 14 to permit the various wheel assemblies 26, 28, 30 to be coupled thereto.

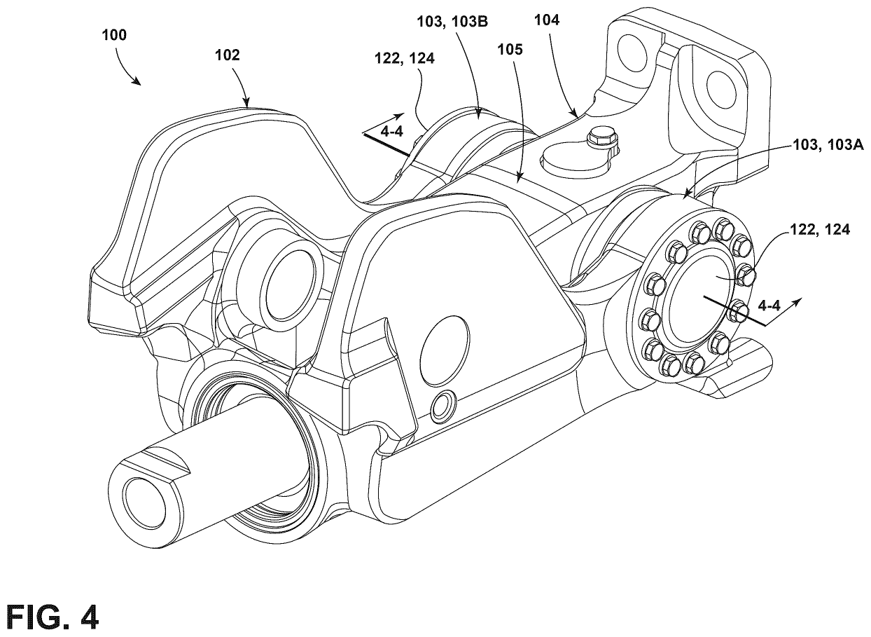

As illustrated in FIG. 2, various pivot joint locations of the track assembly 12, 14 at which a pivot joint may be positioned may be identified. As described herein, a pivot joint or pivot joint assembly may refer to any pivotable connection between two or more different members. Generally, pivot joints permit relative movement between members connected at the pivot joint. For example, pivot joint assembly 100 described below with reference to FIGS. 4 through 6 may be located at any pivot joint location, such as those identified herein.

In one embodiment, one or more components of the suspension system 24 may be pivotally supported on the vehicle chassis 16 (FIG. 1) by two pivot joint assemblies, namely an outboard pivot joint assembly, e.g., pivot joint assembly 100, at a first pivot joint location 34 and an inboard pivot joint assembly, e.g., pivot joint assembly 100, at a second pivot joint location (not shown). The first pivot joint location 34 and, thus, the outboard pivot joint assembly, is located outboard of the drive wheel 22 while the second pivot joint location and, thus, the inboard pivot joint assembly is located inboard of the drive wheel 22 and is secured on the vehicle chassis 16. In one embodiment, the outboard pivot joint assembly may be configured to be coupled between an undercarriage bearing support member 38 and one or more of the undercarriage support beams of the suspension system 24. For example, the outboard pivot joint assembly may be configured to be received through both the undercarriage bearing support member 38 and a portion of the adjacent undercarriage support beam(s), e.g., undercarriage support beam 32. The undercarriage bearing support member 38 may, in turn, be secured at each of its ends to support posts (not shown) coupled to the vehicle chassis 16. As such, the outboard pivot joint assembly may serve to pivotally couple the undercarriage support beam(s) to the vehicle chassis 16.

It should be appreciated that a similar pivotal support arrangement may also be provided on the vehicle chassis 16 inboard of the drive wheel 22 utilizing the inboard pivot joint assembly. For example, the inboard pivot joint assembly may be configured to be received within a suitable opening defined in the adjacent undercarriage support beam(s) for pivotally coupling the support beam(s) to the vehicle chassis 16.

It should also be appreciated that the track assembly 12, 14 shown in FIG. 2 is simply illustrated to provide one example of a suitable track assembly configuration. In other embodiments, the track assembly 12, 14 may have any other suitable track-based configuration.

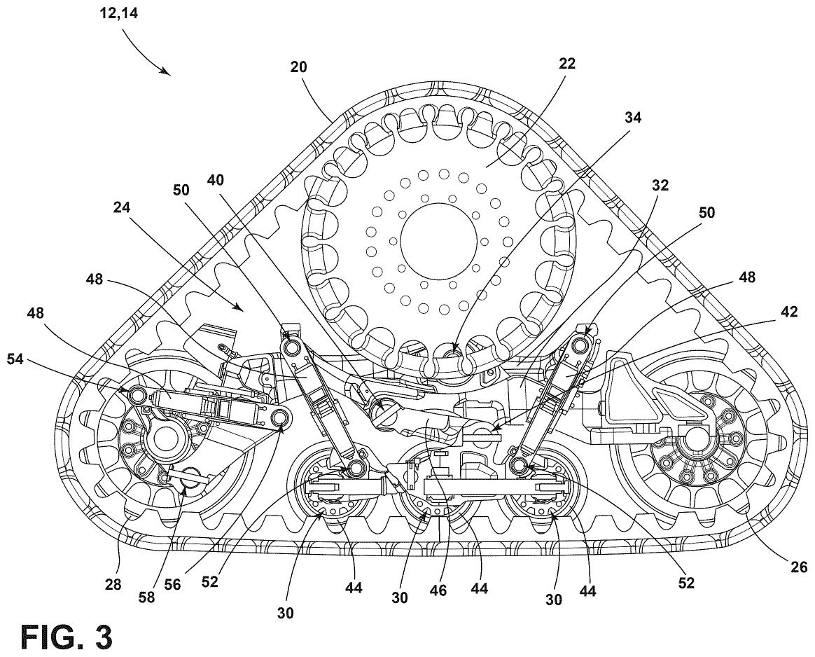

Referring to FIG. 3, a side view of one embodiment of a track assembly for use with the work vehicle 10, such as the track assembly 12, 14, is illustrated. Particularly, an interior side of the track assembly 12, 14 is illustrated with multiple components of the track assembly 12, 14 exposed. For example, one embodiment of the disclosed suspension system 24 that may be used to couple the roller wheel assemblies 30 to the undercarriage support beam 32 is shown in FIG. 3, with the undercarriage support beam 32 having idler wheel assemblies 26, 28 and roller wheel assemblies 30 coupled thereto.

Each roller wheel assembly 30 may include a roller wheel 44 and a roller shaft (not shown) coupled to the roller wheel 44. In several embodiments, the roller shaft may correspond to a fixed or non-rotating shaft. In such embodiments, the roller wheel 44 may be configured to rotate relative to the roller shaft as the track 20 moves relative to the roller wheel 44 in a continuous loop during operation of the work vehicle 10. For instance, the roller wheel 44 may be coupled to the roller shaft via a bearing (not shown) to permit the roller wheel 44 to rotate relative to the shaft.

Additionally, the roller wheel assemblies 30 may be coupled to the undercarriage support beam 32 by a trail arm 46 and/or one or more damping members 48, which may form a portion of several pivot joint assemblies, e.g., pivot joint assemblies 100, along with the roller wheel assemblies 30 and/or the undercarriage support beam 32. For example, one pivot joint assembly may be at least partially formed by the trail arm 46 and the undercarriage support beam 32 at a third pivot joint location 40 and a different pivot joint assembly may be at least partially formed by the trail arm 46 and the roller wheel assemblies 30 at a fourth pivot joint location 42. Likewise, one pivot joint assembly may be at least partially formed by the damping member(s) 48 and the undercarriage support beam 32 at a fifth pivot joint location 50 and a different pivot joint assembly may be at least partially formed by the damping member(s) 48 and the roller wheel assemblies 30 at a sixth pivot joint location 52. The pivot joint assemblies at the third, fourth, fifth, and sixth pivot joint locations 40, 42, 50, 52 may permit the roller wheel assemblies 30 to move relative to the undercarriage support beam 32. For example, the roller wheel assemblies 30 may be permitted to move both vertically and horizontally relative to the undercarriage support beam 32 to provide improved weight distribution as the work vehicle 10 is being driven over uneven or angled driving surfaces, such as a crowned road. Additionally, as illustrated in FIG. 3, pivot joint assemblies may be at least partially formed by various other components of track assembly 12, 14, such as by a damping member 48 and one of the idler wheel assemblies 26, 28 at a seventh pivot joint location 54, by one of the idler wheel assemblies 26, 28 and the undercarriage support beam 32 at an eighth pivot joint location 56, and by idler wheel assembly 28 and the undercarriage support beam 32 at a ninth pivot joint location 58.

While multiple pivot joint locations, e.g., the pivot joint locations 34, 40, 42, 50, 52, 54, 56, 58 are identified within the figures and described herein, it should be appreciated that pivot joint assemblies may be located at any other suitable location(s) on the track assembly 12, 14 or on any other suitable track assembly in order to provide relative movement between various parts or components of the track assembly. Furthermore, it should be appreciated that the pivot joint assembly locations at which the pivot joint assemblies may be located or positioned on may be on any other suitable work machine known in the art, including those for agricultural and construction applications, transport, sport, and/or the like.

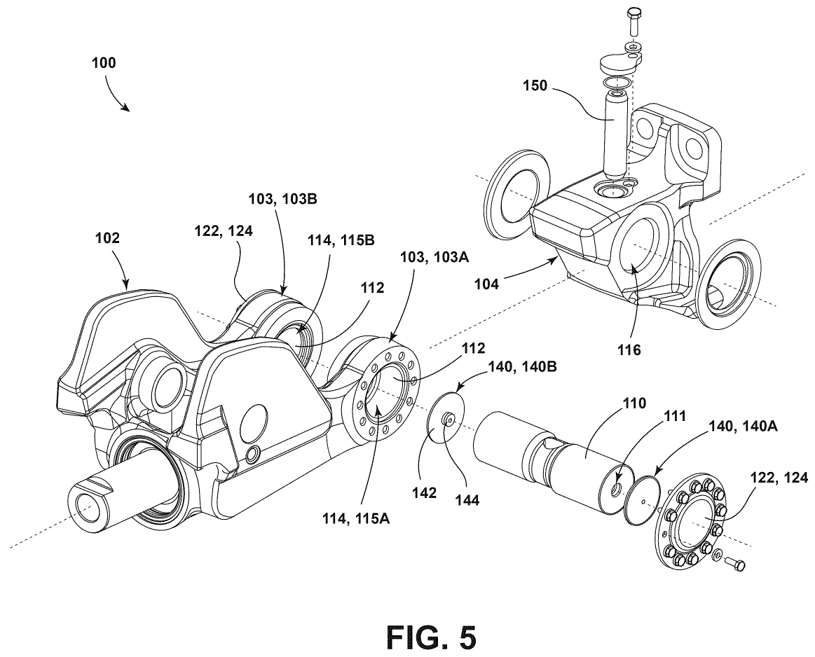

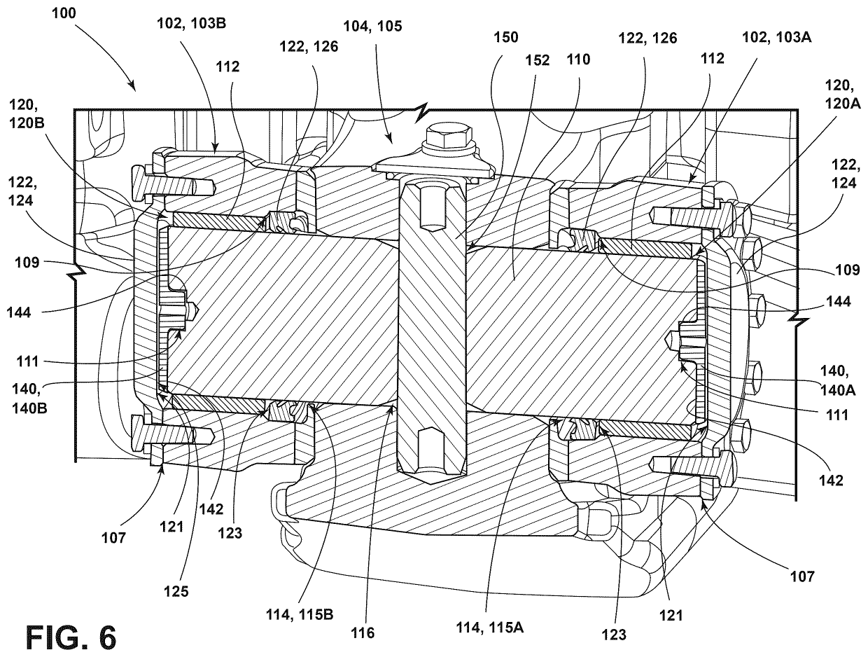

Referring now to FIGS. 4 through 6, various views of one embodiment of a pivot joint assembly 100 are illustrated in accordance with aspects of the present subject matter. Specifically, FIG. 4 illustrates a perspective view of the pivot joint assembly 100. FIG. 5 illustrates a partially exploded view of the pivot joint assembly 100, thus exposing various components of the pivot joint assembly 100, which are described hereinbelow. FIG. 6 illustrates a side cross-sectional view of the pivot joint assembly 100 taken about line 4-4 in FIG. 4.

As illustrated in the figures, in several embodiments, the pivot joint assembly 100 includes a plurality of members, such as a first member 102 and a second member 104, which may be rotatable relative to each other. As described herein, the first and second members 102, 104 may be any suitable members. For example, in several embodiments, the first and/or second members 102, 104 may be components of the track assembly 12, 14 described above, such as the roller wheel assembly(ies) 30, undercarriage support beam 32, the undercarriage bearing support member 38, the trail arm 46, the damping member(s) 48, and/or any other suitable member of the track assembly 12, 14 configured to move relative to other components of the track assembly 12, 14. Additionally, while described herein in the context of a track assembly, it should be appreciated that the first and/or second members 102, 104 may be any suitable members of work vehicle 10 or any other suitable work machine known in the art, including those for agricultural and construction applications, transport, sport, and/or the like.

As illustrated particularly in FIGS. 4 and 6, the first member 102 and the second member 104 may be connected or coupled together, such as by a pivot pin 110 of the pivot joint assembly 100, which may extend axially through the first and second members 102, 104 simultaneously. The pivot pin 110 may be retained within the first and second members 102, 104 by various components, such as by one or more thrust elements 140, sealing elements 122, retaining elements 150, e.g., retaining pin, bolt, and/or the like, while the pivot pin 110 extends axially through the first and second members 102, 104. The pivot joint assembly 100 may also include one or more pivot pin bearings 112 that encircle the pivot pin 110. The pivot pin bearing(s) 112 permit relative rotation between the first and second members 102, 104, such as rotation of the first member 102 about the pivot pin bearing(s) 112 relative to the second member 104.

In several embodiments, the pivot joint assembly 100 may be configured as a clevis-type pivot joint assembly. For example, as illustrated in FIGS. 4 through 6, the first member 102 may include two sections 103, a first section 103A and a second section 103B, spaced apart from each other. The first and second sections 103A, 103B may be first and second arms 103A, 103B respectively, that extend from a base. The second member 104 may include a single section or arm 105 that may be received and positioned between the two arms 103 of the first member 102 for coupling the first member 102 and the second member 104 together, e.g., with the pivot pin 110. However, it should be appreciated that the first member 102 and the second member 104 may each include any suitable number of sections or arms. For example, in several embodiments, the first member 102 and the second member 104 may each include only one section or arm. In some other embodiments, the first member 102 and the second member 104 may each include a plurality of sections or arms spaced apart from each other such that the sections or arms of each of the first member 102 and the second member 104 are positioned between the sections or arms of the other of the first member 102 or the second member 104.

Additionally, as particularly illustrated in FIGS. 5 and 6, a first pin channel 114 may be defined through the first member 102, such as through each arm 103 thereof. As such, the first and second arms 103A, 103B may define a first portion 115A and a second portion 115B of the first pin channel 114, respectively. The two arms 103 of the first member 102 may be positioned relative to each other such that the first pin channel 114 is axially aligned and the pivot pin 110 may extend axially through the arms 103 simultaneously. Likewise, a second pin channel 116 may be defined through the second member 104. The second member 104 may be positioned relative to the first member 102, such as between the arms 103 of the first member 102, such that the second pin channel 116 is axially aligned with the first pin channel 114. In this respect, the pivot pin 110 may extend axially through the aligned first and second pin channels 114, 116 of the first and second members 102, 104 simultaneously.

In several embodiments, one or more sealed chambers 120 may be formed within the first member 102 and/or the second member 104. For example, at least a portion of the first pin channel 114 may be sealed to form the sealed chamber(s) 120. As illustrated in FIG. 6, in several embodiments, a portion of the first pin channel 114 within each arm 103 of the first member 102 may be sealed to form two sealed chambers 120, a first sealed chamber 120A and a second sealed chamber 120B, one in each arm 103. Specifically, first and second sealed chambers 120A, 120B may be formed within the first and second portions 115A, 115B of the first pin channel 114, respectively. However, it should be appreciated that in some other embodiments, only one sealed chamber 120 may be formed or more than two sealed chambers 120 may be formed. The sealed chamber(s) 120 may be sealed to prevent matter, such as dirt or dust particles, from entering the sealed chamber(s) 120.

In several embodiments, the pivot joint assembly 100 includes one or more sealing elements 122 for sealing the sealed chamber(s) 120. For example, as illustrated in FIG. 6, the pivot joint assembly 100 may include a first sealing element 124 and a second sealing element 126 for sealing the sealed chamber 120 of each of the arms 103. The first and second sealing elements 124, 126 may be positioned relative to the first pin channel 114 and spaced axially apart from each other such that the sealed chamber 120 is axially defined between the first and second sealing elements 124, 126. As illustrated in FIG. 6, in one embodiment, the first sealing element 124 may be positioned at an axially outer end 107 of the first member 102 and configured to seal a portion of the first pin channel 114 to form a first axial side 121 of the sealed chamber 120. For example, the first sealing element 124 may include an axially inner wall 125, which may seal the portion of the first pin channel 114 to form the first axial side 121 of the sealed chamber 120. Likewise, in one embodiment, the second sealing element 126 may be positioned radially between the pivot pin 110 and an interior surface 109 of the first member 102 and configured to seal a portion of the first pin channel 114 to form a second axial side 123 of the sealed chamber 120. As illustrated in the figures, the first sealing element 124 may be configured as an outer cap 124. Likewise, the second sealing element 126 may be configured as a pin seal 126, e.g., O-ring, which encircles the pivot pin 110. However, it should be appreciated that, in some other embodiments, the first sealing element 124 and/or the second sealing element 126 may be any suitable sealing element.

In several embodiments, the pivot joint assembly 100 may include various components that are positioned within the sealed chamber(s) 120 or form at least a portion of the sealed chamber(s) 120. For example, as illustrated in FIG. 6, a portion of the pivot pin 110 is positioned within the sealed chamber 120 of each arm 103 of the first member 102. Additionally, as illustrated in FIGS. 5 and 6, the pivot joint assembly 100 includes a pivot pin bearing 112 positioned within the sealed chamber 120 of each arm 103 of the first member 102. In this respect, in several embodiments, the pivot pin bearing 112 is positioned axially between the first and second sealing elements 124, 126, e.g., outer cap 124 and pin seal 126. The pivot pin bearing 112 may encircle the pivot pin 110, e.g., a portion of thereof positioned within the sealed chamber(s) 120, and, thus, be positioned between the pivot pin 110 and the interior surface 109 of the first member 102. The pivot pin bearing 112 may permit relative rotation between the first and second members 102, 104. For example, the pivot pin bearing 112 may permit the first member 102 to rotate about the pivot pin 110 relative to the second member 104.

Additionally, as illustrated in FIGS. 5 and 6, the pivot joint assembly 100 includes one or more thrust elements 140, e.g., first and second thrust elements 140A, 140B, positioned within the sealed chambers 120 or forming at least a portion of the sealed chambers 120 of the arms 103 of the first member 102. In some embodiments, the thrust elements 140 may be configured as thrust washers 140, e.g., first and second thrust washers 140A, 140B. Specifically, the first and second thrust washers 140A, 140B may be positioned within the first and second sealed chambers 120A, 120B respectively. In this respect, in several embodiments, the thrust washer 140 is positioned axially between the first and second sealing elements 124, 126, e.g., the outer cap 124, such as the axially inner wall 125 thereof, and the pin seal 126. Additionally, the thrust washer 140 may be positioned axially between the pivot pin bearing 112 and the first sealing element 124, e.g., the outer cap 124, which, as described above, may be positioned at the axially outer end 107 of the first member 102. For example, in one embodiment, the thrust washer 140 may be positioned axially between the pivot pin 110, e.g., an axial end thereof, and the first sealing element 124, e.g., the outer cap 124. However, in some embodiments, the thrust element 140 may define or form at least a portion of a wall of the first sealing element 124, particularly the axially inner wall 125 thereof. As such, each axially inner wall 125, at least a portion of which is defined by the thrust element 140, seals a portion of the first pin channel 114 to form the first axial side 121 of the sealed chamber 120.

Furthermore, the thrust elements 140 are generally configured to limit or prevent axial movement of the pivot pin 110. For example, as illustrated in FIGS. 5 and 6, in one embodiment, each thrust element 140 may include a base 142 and a mounting hub 144 protruding from the base 142. For embodiments in which the thrust element 140 defines at least a portion of the axially inner wall 125 of the first sealing element 124, the base 142 may be the same as the axially inner wall 125. The mounting hub 144 may extend axially from the base 142 and through hub channel 111 defined through the pivot pin 110, e.g., one hub channel 111 through each axial end of the pivot pin 110. In this respect, the pivot pin 110 may be positioned or sandwiched between two thrust elements 140, each of which is positioned in a different one of the sealed chambers 120 of the arms 103 of the first member 102. As such, the thrust elements 140 may limit or prevent axial movement of the pivot pin 110, such as relative to the first member 102 and the second member 104. Moreover, the thrust elements 140 and, thus, the pivot pin 110, may be positioned or sandwiched between the first sealing elements 124, e.g., the outer caps 124.

Moreover, in several embodiments, the pivot joint assembly 100 includes a retaining element 150, such as a pin or bolt, for constraining movement of the pivot pin 110 relative to the first and second members 102, 104. The retaining element 150 may simultaneously extend through the pivot pin 110 and the first and/or second member 102, 104. For example, as illustrated in FIG. 6, in one embodiment, the pivot pin 110 and the second member 104 collectively define a retaining element channel 152 while the pivot pin 110 extends axially through the aligned first and second pin channels 114, 116 of the first and second members 102, 104. The retaining element 150 may extend axially through the retaining element channel 152 and, thus, simultaneously through the pivot pin 110 and the second member 104. In this respect, movement, e.g., rotational and/or axial, of the pivot pin 110 may be constrained relative to the first and second members 102, 104.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A track assembly for a track-driven work machine, the track assembly comprising:
a track;
a drive wheel configured to engage the track;
an idler wheel around which the track is wrapped; and
a pivot joint assembly, comprising:
a first member defining a first pin channel, at least a portion of the first pin channel being sealed to form a sealed chamber;
a second member defining a second pin channel, the second member positioned relative to the first member such that the second pin channel of the second member is axially aligned with the first pin channel of the first member;
a pivot pin extending axially through the aligned first and second pin channels of the first and second members, respectively; and
a thrust element positioned within the sealed chamber or forming at least a portion of the sealed chamber of the first member.

2. The track assembly of claim 1, the pivot joint assembly further comprising:
a bearing positioned within the sealed chamber of the first member and encircling the pivot pin, the first member configured to rotate about the bearing relative to the second member.

3. The track assembly of claim 1, wherein the thrust element comprises a thrust washer, the thrust washer positioned within the sealed chamber of the first member.

4. The track assembly of claim 3, the pivot joint assembly further comprising:
a sealing element positioned at an axially outer end of the first member and being configured to seal a portion of the first pin channel to form a first axial side of the sealed chamber;
wherein the thrust washer is positioned axially between the pivot pin and the sealing element.

5. The track assembly of claim 4, the pivot joint assembly further comprising:
a bearing positioned within the sealed chamber of the first member and encircling the pivot pin, the first member configured to rotate about the bearing relative to the second member;
wherein the thrust washer is positioned axially between the bearing and the sealing element.

6. The track assembly of claim 3, the pivot joint assembly further comprising:
a first sealing element and a second sealing element, the first and second sealing elements positioned relative to the first pin channel and being spaced axially apart from each other such that the sealed chamber is defined axially between the first and second sealing elements;
wherein the thrust washer is positioned axially between the first and second sealing elements.

7. The track assembly of claim 6, the pivot joint assembly further comprising:
a bearing positioned axially between the first and second sealing elements and encircling the pivot pin, the first member configured to rotate about the bearing relative to the second member.

8. The track assembly of claim 7, wherein one of the first sealing element or the second sealing element comprises an outer cap positioned at an axially outer end of the first member and being configured to seal a portion of the first pin channel to form a first axial side of the sealed chamber;
wherein the thrust washer is positioned axially between the pivot pin and the outer cap.

9. The track assembly of claim 8, wherein the other of the first sealing element or the second sealing element comprises a pin seal encircling the pivot pin, the pin seal positioned radially between the pivot pin and an interior surface of the first member and configured to seal a portion of the first pin channel to form a second axial side of the sealed chamber.

10. The track assembly of claim 1, the thrust element comprising:
a base; and
a mounting hub extending axially through a hub channel defined through the pivot pin.

11. The track assembly of claim 1, the pivot joint assembly further comprising:
a retaining element;
wherein the pivot pin and the second member collectively define a retaining element channel while the pivot pin extends axially through the aligned first and second pin channels of the first and second members, the retaining element extending axially through the retaining element channel.

12. The track assembly of claim 1, the pivot joint assembly further comprising:
a sealing element positioned at an axially outer end of the first member, the thrust element defining at least a portion of a wall of the sealing element, the sealing element being configured to seal a portion of the first pin channel to form a first axial side of the sealed chamber.

13. The track assembly of claim 12, wherein the wall of the sealing element is an axially inner wall, the axially inner wall sealing the portion of the first pin channel to form the first axial side of the sealed chamber.

14. A pivot joint assembly for a work machine, comprising:
a first member defining a first pin channel, at least a portion of the first pin channel being sealed to form a sealed chamber;
a second member defining a second pin channel, the second member positioned relative to the first member such that the second pin channel of the second member is axially aligned with the first pin channel of the first member;
a pivot pin extending axially through the aligned first and second pin channels of the first and second members, respectively; and
a thrust element positioned within the sealed chamber or forming at least a portion of the sealed chamber of the first member.

15. The pivot joint assembly of claim 14, further comprising:
a sealing element positioned at an axially outer end of the first member and being configured to seal a portion of the first pin channel to form a first axial side of the sealed chamber;
wherein the thrust element comprises a thrust washer, the thrust washer positioned within the sealed chamber of the first member axially between the pivot pin and the sealing element.

16. The pivot joint assembly of claim 14, the pivot joint assembly further comprising:
a sealing element positioned at an axially outer end of the first member, the thrust element defining at least a portion of a wall of the sealing element, the sealing element being configured to seal a portion of the first pin channel to form a first axial side of the sealed chamber.

17. The pivot joint assembly of claim 14, wherein:
the pivot joint assembly is a clevis pivot joint assembly; and
the first member comprises a first arm and a second arm spaced apart from the first arm.

18. The pivot joint assembly of claim 17, wherein:
the first arm and the second arm define a first portion and a second portion of the first pin channel, respectively.

19. The pivot joint assembly of claim 18, wherein:
the sealed chamber is a first sealed chamber within the first portion of the first pin channel; and
the second portion of the first pin channel defines a second sealed chamber.

20. The pivot joint assembly of claim 19, wherein:
the thrust element is a first thrust element positioned within the first sealed chamber or forming at least a portion of the first sealed chamber; and
the pivot joint assembly further comprising a second thrust element positioned within the second sealed chamber or forming at least a portion of the second sealed chamber.
